(19) United States
(12) Patent Application Publication
(10) Pub. No.: US 2008/0137570 A1
(43) Pub. Date: Jun. 12, 2008

(54) DUAL MODE WPAN TRANSCEIVER

(75) Inventors: Sang Hyun MIN, Yongin (KR); Tah Joon Park, Gyunggi-do (KR); Koon Shik Cho, Seoul (KR); Jae Hyung Lee, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/951,040

(22) Filed: Dec. 5, 2007

(30) Foreign Application Priority Data
Dec. 6, 2006 (KR) 10-2006-0123288

(51) Int. Cl. H04B 7/00; H04L 27/00

(52) U.S. Cl. 370/310; 375/295; 375/316

(57) ABSTRACT

There is provided a dual mode WPAN transceiver including a dual mode WPAN transmitter and a dual mode WPAN receiver. In the dual mode WPAN transceiver, the dual mode WPAN transmitter includes a low-speed spreading transmission block spreading low bit-rate data corresponding to a low data rate in low data rate mode, and a high-speed encoding transmission block encoding high bit-rate data corresponding to a high data rate in high data rate mode, and the dual mode WPAN receiver includes an A/D block converting analog I and Q signals into digital I and Q signals, a differential block obtaining a phase difference between the digital I and Q signals from the A/D unit and complex signals adjacent thereto to offset phase errors of the digital I and Q signals, a low-speed despreading reception unit despreading the digital I and Q signals differentiated by the differential block to detect low bit-rate data in low data rate mode, and a high-speed decoding reception unit decoding the digital I and Q signals differentiated by the differential block to detect high bit-rate data.

### CROSS-REFERENCE TO RELATED APPLICATIONS

This application claims the priority of Korean Patent Application No. 2006-123288 filed on Dec. 6, 2006, in the Korean Intellectual Property Office, the disclosure of which is incorporated herein by reference.

### BACKGROUND OF THE INVENTION

1. Field of the Invention

The present invention relates to a dual mode WPAN transceiver, and more particularly, to a dual mode WPAN transceiver that can support low-speed data communication of 250 kbps and high-speed data communication of 2 Mbps without increasing the system size, such that a data communication rate can be appropriately determined according to a channel environment to thereby improve the system's adaptability.

2. Description of the Related Art

In general, the IEEE 802.15.4 physical layer standard is a standard for a wireless personal network (WPAN), which is known as Zigbee, and has the advantages of low data rates, low power consumption, and low costs. The expected applications of Zigbee include controls and networks, such as building control, a home network (various kinds of home appliances, lighting, and the like), cooling and heating control, air conditioning control, and a sensor network.

Zigbee conforms to the IEEE 802.15.4 standard, in which a low data rate of 250 Kbps is only defined. Low data rates will be sufficient if the application of Zigbee is a simple control operation. However, in order to use Zigbee for various purposes in various application environments, high data rates will be required as well as the low data rates.

In a case of Bluetooth, which is another wireless personal area network (WPAN) standard similar to the Zigbee, chips have been released to vary data rates. In addition, some Zigbee IC makers have been developing dual data rate chips for supporting both low data rates and high data rates, which are arbitrarily determined by the makers. Here, examples of the high data rates may include 625 kbps, 1 Mbps, and the like. That is, the high data rates may vary according to the IC makers.

FIGS. 1A and 1B are configuration views illustrating a WPAN transceiver. FIG. 1A is a configuration view illustrating a WPAN transmitter, and FIG. 1B is a configuration view illustrating a WPAN receiver.

The WPAN transceiver includes a WPAN transmitter that transmits signals at a low data rate according to a data spreading process, and a WPAN receiver that receives the signals from the WPAN receiver to detect data according to a non-spreading process.

Referring to FIG. 1A, the WPAN transmitter that only supports a data rate of 250 kbps includes a low-speed spreading transmission unit 11 and an analog waveform generating unit 12. The low-speed spreading transmission block 11 spreads low bit-rate data and converts the low bit-rate data into an I signal DI and a Q signal. The analog waveform generating unit 12 converts the I signal DI and the Q signal DQ from the low-speed spreading transmission unit 11 into analog I and Q signals AI and AQ.

Then, the analog I and Q signals from the analog waveform generating block 12 are transmitted to an RF transmitting unit. The RF transmission unit transmits the analog I and Q signals.

Referring to FIG. 1B, the WPAN receiver includes an A/D unit 21, a differential unit 22, a timing estimation unit 23, and a low-speed despreading reception unit 24. The A/D unit 21 converts the analog I and Q signals AI and AQ into digital I and Q signals DI and DQ. The differential unit 22 obtains a phase difference between the digital I and Q signals DI and DQ from the A/D unit 21 and complex signals adjacent thereto to offset phase errors of the digital I and Q signals DI and DQ. The timing estimation unit 23 estimates a timing synchronization point on the basis of preamble information of digital I and Q signals DDI and DDQ that are differentiated by the differential unit 22. The low-speed despreading reception unit 24 despreads the digital I and Q signals DDI and DDQ differentiated by the differential unit 22 according to the timing synchronization point estimated by the timing estimation unit 23 to detect low bit-rate data.

At this time, the despreading of the low-speed despreading reception unit 24 includes a correlation process of obtaining correlation values on the basis of the digital I and Q signals DDI and DDQ differentiated by the differential unit 22, a symbol detecting process of obtaining a symbol that corresponds to a maximum correlation value among the correlation values obtained by the correlation process, and a bit acquiring process of acquiring bit data that is mapped to the detected symbol.

However, since the above-described WPAN transceiver according to the related art only supports a data rate of approximately 250 kbps, the WPAN transceiver can only support a standard data rate of 250 kbps but cannot support high data rates exceeding 250 kbps.

### SUMMARY OF THE INVENTION

An aspect of the present invention provides a dual mode WPAN transceiver that can support low-speed data communication of 250 kbps and high-speed data communication of 2 Mbps without increasing the system size, such that a data communication rate can be appropriately determined according to channel environment to thereby improve the system's adaptability.

According to an aspect of the present invention, there is provided a dual mode WPAN transmitter including a low-speed spreading transmission block spreading low bit-rate data corresponding to a low data rate and dividing the low bit-rate data into digital I and Q signals in low data rate mode, a high-speed encoding transmission block encoding high bit-rate data corresponding to a high data rate and dividing the high bit-rate data into digital I and Q signals in high data rate mode, and an analog waveform generating block converting the digital I and Q signals from the low-speed spreading transmission block or the high-speed encoding transmission block into analog I and Q signals.

According to another aspect of the present invention, there is provided a dual mode WPAN receiver including an A/D block converting analog I and Q signals into digital I and Q signals, a differential block obtaining a phase difference between the digital I and Q signals from the A/D block and complex signals adjacent thereto to offset phase errors of the digital I and Q signals, a timing estimation block estimating a timing synchronization point on the basis of preamble information of the digital I and Q signals differentiated by the differential block, a low-speed despreading reception unit despreading the digital I and Q signals differentiated by the differential block according to the timing synchronization point estimated by the timing estimation block to detect low bit-rate data, and stopping the operation in high data rate mode, a data rate determining block determining whether it is a low data rate mode or a high data rate mode on the basis of data rate information included in the low bit-rate data from the low-speed despreading reception unit, and a high-speed decoding reception unit decoding the digital I and Q signals differentiated by the differential block according to the timing synchronization point estimated by the timing estimation block to detect high bit-rate data.

According to still another aspect of the present invention, there is provided a dual mode WPAN transceiver including: a WPAN transmitter including a low-speed spreading transmission block spreading low bit-rate data corresponding to a low data rate and dividing the low bit-rate data into digital I and Q signals in low data rate mode, a high-speed encoding transmission block encoding high bit-rate data corresponding to a high data rate and dividing the high bit-rate data into digital I and Q signals in high data rate mode, and an analog waveform generating block converting the digital I and Q signals from the low-speed spreading transmission block or the high-speed encoding transmission block into analog I and Q signals; and a WPAN receiver including an A/D block converting analog I and Q signals into digital I and Q signals, a differential block obtaining a phase difference between the digital I and Q signals from the A/D block and complex signals adjacent thereto to offset phase errors of the digital I and Q signals, a timing estimation block estimating a timing synchronization point on the basis of preamble information of the digital I and Q signals differentiated by the differential block, a low-speed despreading reception unit despreading the digital I and Q signals differentiated by the differential block according to the timing synchronization point estimated by the timing estimation block to detect low bit-rate data, and stopping the operation in high data rate mode, a data rate determining block determining whether it is a low data rate mode or a high data rate mode on the basis of data rate information included in the low bit-rate data from the low-speed despreading reception unit, and a high-speed decoding reception unit decoding the digital I and Q signals differentiated by the differential block according to the timing synchronization point estimated by the timing estimation block to detect high bit-rate data.

The low-speed spreading transmission block may include a bit/symbol converting unit dividing the low bit-rate data corresponding to the low data rate into groups of bits, each group having a predetermined number of bits, and converting the data divided into groups of bits into symbols previously mapped, a symbol/chip converting unit converting each of the symbols from the bit/symbol converting unit into a chip signal having a plurality of chips and previously mapped, and a serial/parallel converting unit dividing a serial chip signal from the symbol/chip converting unit into odd-numbered chips and even-numbered chips to generate digital I and Q signals.

The low bit-rate data may have a data packet structure including a preamble field containing preamble information for estimating timing synchronization, a start frame delimiter field indicating a start frame, a frame length field indicating a frame length, and a payload field containing actual data, and includes low data rate mode information as data rate information in the frame length field.

The low data rate mode information may be included in the most significant bit of the frame length field

The low data rate may be approximately 250 kbps.

The high-speed encoding transmission block may include a serial/parallel converting unit dividing the high bit-rate data corresponding to the high data rate into an odd-numbered bit sequence and an even-numbered bit sequence, a first encoding unit encoding the odd-numbered bit sequence from the serial/parallel converting unit to generate the digital I signal, and a second encoding unit encoding the even-numbered bit sequence from the serial/parallel converting unit to generate the digital Q signal.

The high bit-rate data may have a data packet structure including a preamble field containing preamble information for estimating timing synchronization, a start frame delimiter field indicating a start frame, a frame length field indicating a frame length, and a payload field containing actual data, and includes high data rate mode information as data rate information in the frame length field.

The high data rate mode information may be included in the most significant bit of the frame length field.

The high data rate may be approximately 2 Mbps.

The analog waveform generating block may include a first pulse shaping unit converting the digital I signal from the low-speed spreading transmission block or the high-speed encoding transmission block into an analog pulse signal, a second pulse shaping unit converting the digital Q signal from the low-speed spreading transmission block or the high-speed encoding transmission block into an analog pulse signal, a first D/A unit converting the analog pulse signal from the first pulse shaping unit into an analog I signal, a delay unit delaying the analog pulse signal from the second pulse shaping unit by a predetermined period of time, and a second D/A unit converting the analog pulse signal from the delay unit into an analog Q signal.

The data rate information may be included in the most significant bit of a frame length field in a packet structure of the digital I and Q signals differentiated by the differential block.

The low-speed despreading reception unit may include a correlation unit correlating the digital I and Q signals differentiated by the differential block to a plurality of reference PN codes set beforehand, a maximum value detecting unit detecting a maximum correlation unit among a plurality of correlation values from the correlation unit, a symbol detecting unit detecting a symbol previously mapped to the maximum correlation value detected by the maximum value detecting unit, and a symbol/bit converting unit converting the symbol detected by the symbol detecting unit into bit data previously mapped to the symbol.

The high-speed decoding reception unit may include an inverting unit inverting the digital Q signal differentiated by the differential block, a bit determining unit determining a bit ‘1’ when the signal from the inverting unit is larger than a reference value and a bit ‘0’ when the signal from the inverter is smaller than the reference value, and a decoding unit decoding a bit signal from the bit determining unit to detect bit data.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B are configuration views illustrating a WPAN transceiver.

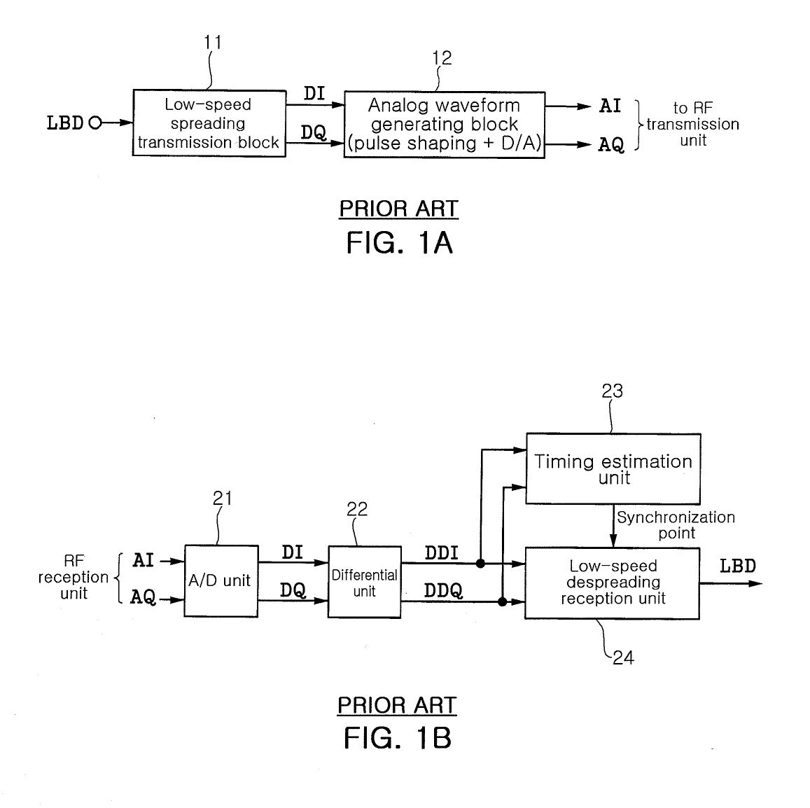

FIG. 2 is a configuration view illustrating a dual mode WPAN transmitter according to one exemplary embodiment of the present invention.

FIG. 3 is a configuration view illustrating a low-speed spreading transmission block shown in FIG. 2.

FIG. 4 is a configuration view illustrating a high-speed encoding transmission block shown in FIG. 2.

FIG. 5 is a configuration view illustrating an analog waveform generating block shown in FIG. 2.

FIG. 6 is a configuration view illustrating a dual mode WPAN receiver according to another exemplary embodiment of the present invention.

FIG. 7 is a configuration view illustrating a low-speed despreading reception unit shown in FIG. 6.

FIG. 8 is a configuration view illustrating a high-speed decoding reception unit shown in FIG. 6.

FIGS. 9A and 9B are structural views illustrating a low bit-rate data packet and a high bit-rate data packet.

### DETAILED DESCRIPTION OF THE PREFERRED EMBODIMENT

Exemplary embodiments of the present invention will now be described in detail with reference to the accompanying drawings.

The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Further, it should be understood that like reference numerals refer to like elements having the same configurations and functions in the accompanying drawings.

One exemplary embodiment of the present invention relates to a dual mode WPAN transmitter. Another exemplary embodiment of the present invention relates to a dual mode WPAN receiver. Still another exemplary embodiment of the present invention relates to a dual mode WPAN transceiver.

At this time, a dual mode WPAN transceiver according to an exemplary embodiment of the present invention includes a dual mode WPAN transmitter and a dual mode WPAN receiver.

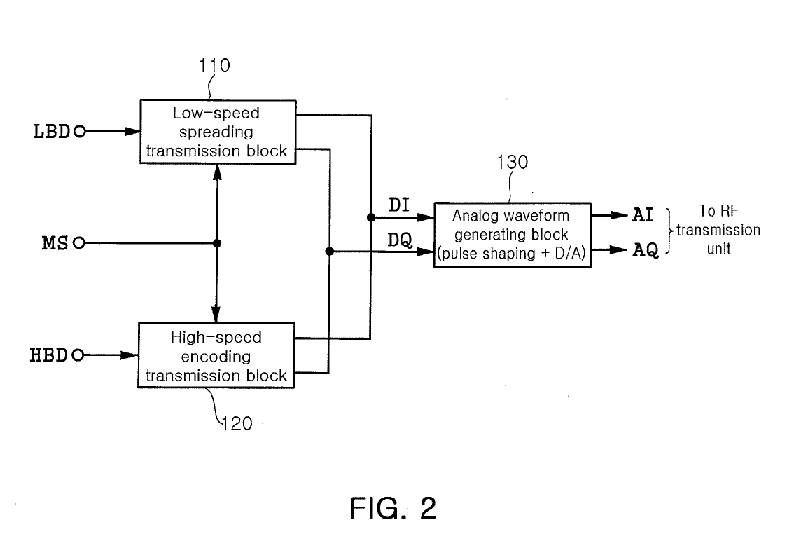

FIG. 2 is a configuration view illustrating a dual mode WPAN transmitter according to one exemplary embodiment of the invention.

Referring to FIG. 2, the dual mode WPAN transmitter according to one exemplary embodiment of the present invention includes a low-speed spreading transmission block 110, a high-speed encoding transmission block 120, and an analog waveform generating block 130. In low data rate mode, the low-speed spreading transmission block 110 spreads low bit-rate data LBD corresponding to a low data rate and divides the low bit-rate data LBD into digital I and Q signals DI and DQ. In high data rate mode, the high-speed encoding transmission block 120 encodes high bit-rate data HBD corresponding to a high data rate into digital I and Q signals DI and DQ. The analog waveform generating block 130 converts the digital I and Q signals DI and DQ from the low-speed spreading transmission block 110 or the high-speed encoding transmission block 120 into analog I and Q signals AI and AQ.

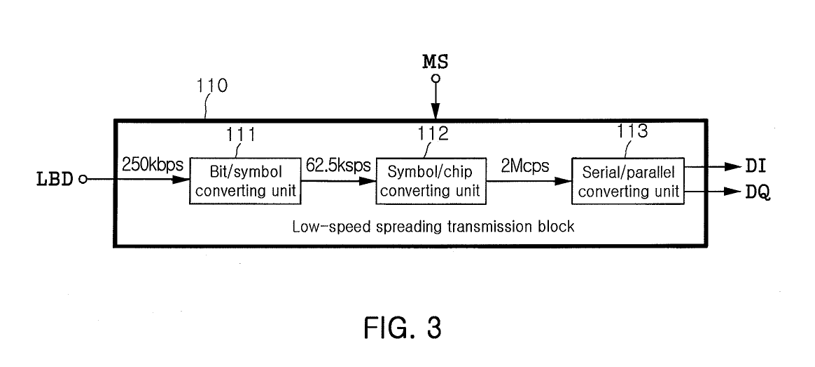

FIG. 3 is a configuration view illustrating a low-speed spreading transmission block shown in FIG. 2.

Referring to FIG. 3, the low-speed spreading transmission block 110 includes a bit/symbol converting unit 111, a symbol/chip converting unit 112, and a serial/parallel converting unit 113. The bit/symbol converting unit 111 divides the low bit-rate data LBD corresponding to the low data rate into groups of bits, each group having a predetermined number of bits, and converts data divided into groups of bits into symbols that are previously mapped. The symbol/chip converting unit 112 converts each of the symbols from the bit/symbol converting unit 111 into a previously mapped chip signal that includes a plurality of chips. The serial/parallel converting unit 113 divides a serial chip signal from the symbol/chip converting unit 112 into odd-numbered chips and even-numbered chips to generate the digital I and Q signals.

Here, the low data rate may be approximately 250 kbps.

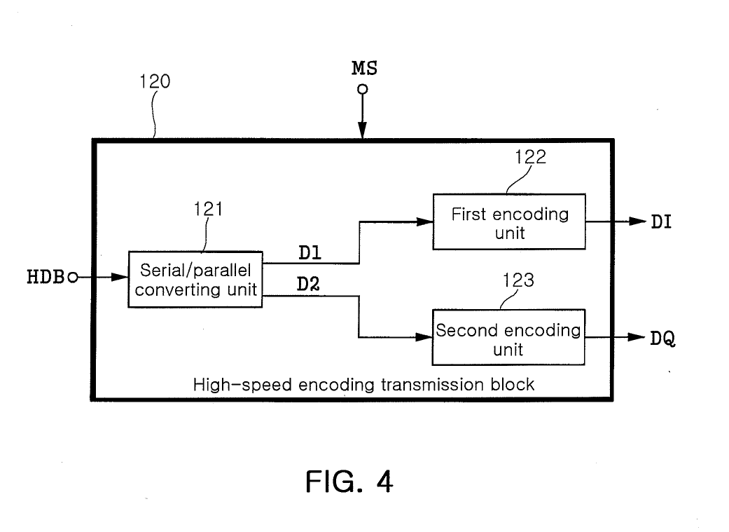

FIG. 4 is a configuration view illustrating a high-speed encoding transmission block shown in FIG. 2.

Referring to FIG. 4, the high-speed encoding transmission block 120 includes a serial/parallel converting unit 121, a first encoding unit 122, and a second encoding unit 123. The serial/parallel converting unit 121 divides the high bit-rate data HBD corresponding to the high data rate into an odd-numbered bit sequence D1 and an odd-numbered bit sequence D2. The first encoding unit 122 encodes the odd-numbered bit sequence D1 from the serial/parallel converting unit 121 to generate the digital I signal. The second encoding unit 123 encodes the even-numbered bit sequence D2 from the serial/parallel converting unit 121 to generate the digital Q signal.

Here, the high data rate may be approximately 2 Mbps.

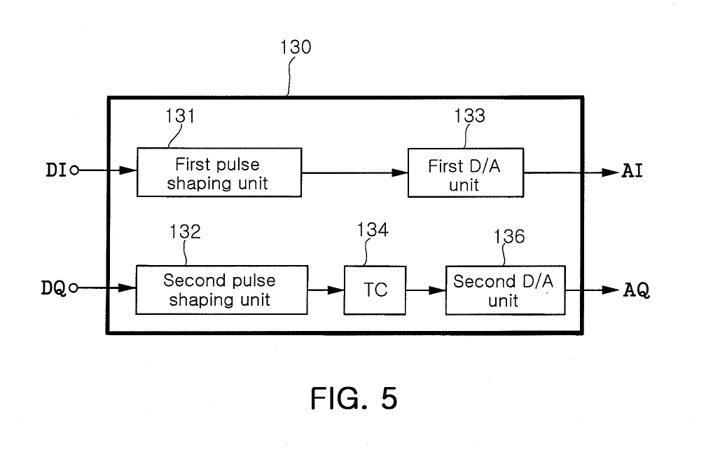

FIG. 5 is a configuration view illustrating an analog waveform generating block shown in FIG. 2.

Referring to FIG. 5, the analog waveform generating block 130 includes a first pulse shaping unit 131, a second pulse shaping unit 132, a first D/A unit 133, a delay unit (TC) 134, and a second D/A unit 136. The first pulse shaping unit 131 converts the digital I signal DI from the low-speed spreading transmission block 110 or the high-speed encoding transmission block 120 into an analog pulse signal. The second pulse shaping unit 132 converts the digital Q signal DQ from the low-speed spreading transmission block 110 or the high-speed encoding transmission block 120 into an analog pulse signal. The first D/A unit 133 converts the analog pulse signal from the first pulse shaping unit 131 into the analog I signal. The delay unit (TC) 134 delays the analog pulse signal from the second pulse shaping unit 132 by a predetermined period of time. The second D/A unit 136 converts the analog pulse signal from the delay unit 134 into an analog Q signal.

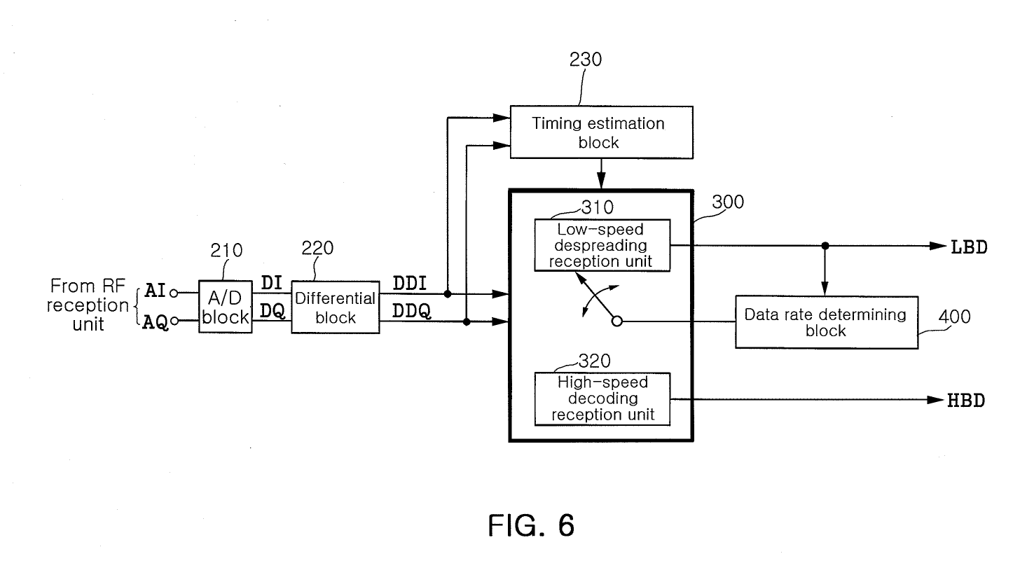

FIG. 6 is a configuration view illustrating a dual mode WPAN receiver according to another exemplary embodiment of the present invention.

Referring to FIG. 6, the dual mode WPAN receiver according to another exemplary embodiment of the present invention includes an A/D block 210, a differential block 220, a timing estimation block 230, a low-speed despreading reception unit 310, a high-speed decoding reception unit 320, and a data rate determining block 400. The A/D block 210 converts the analog I and Q signals AI and AQ into digital I and Q signals DI and DQ. The differential block 220 obtains a phase difference between the digital I and Q signals DI and DQ from the A/D block 210 and complex signals adjacent thereto to offset phase errors of the digital I and Q signals DI and DQ. The timing estimation block 230 estimates a timing synchronization point on the basis of preamble information of digital I and Q signals DDI and DDQ that are differentiated by the differential block 220. The low-speed despreading reception unit 310 despreads the digital I and Q signals DDI and DDQ differentiated by the differential block 220 according to the timing synchronization point estimated by the timing estimation block 230 so as to detect low bit-rate data, and stops the operation in high data rate mode. The data rate determining block 400 determines whether it is a low data rate mode or a high data rate mode on the basis of data rate information that is included in the low bit-rate data from the low-speed despreading reception unit 310. When the data rate determining block 400 determines the high data rate mode, the high-speed decoding reception unit 320 decodes the digital I and Q signals DDI and DDQ, which are differentiated by the differential block 220, according to the timing synchronization point, which is estimated by the timing estimation block 230, so as to detect high bit-rate data.

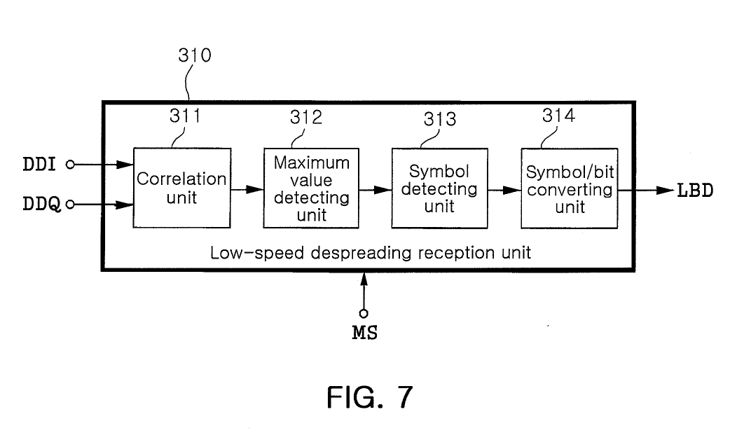

FIG. 7 is a configuration view illustrating a low-speed despreading reception unit shown in FIG. 6.

Referring to FIG. 7, the low-speed despreading reception unit 310 includes a correlation unit 311, a maximum value detecting unit 312, a symbol detecting unit 313, and a symbol/bit converting unit 314. The correlation unit 311 correlates the digital I and Q signals DDI and DDQ, which are differentiated by the differential block 220, to a plurality of reference PN codes that are set beforehand. The maximum value detecting unit 312 detects a maximum correlation value from a plurality of correlation values from the correlation unit 311. The symbol detecting unit 313 detects a symbol that is previously mapped to the maximum correlation value of the maximum value detecting unit 312. The symbol/bit converting unit 314 converts the symbol, which is detected by the symbol detecting unit 313, into bit data that is previously mapped to the symbol.

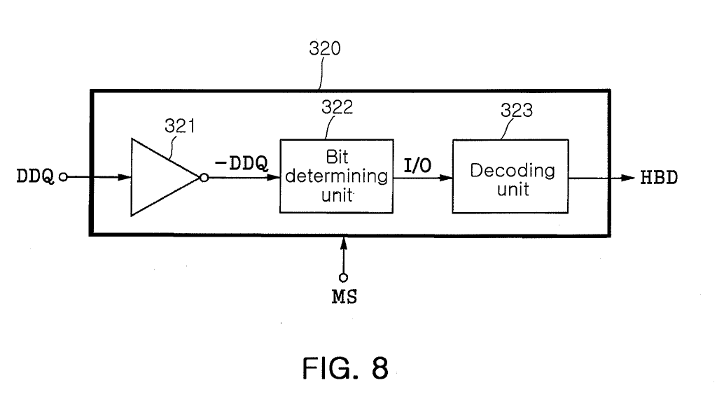

FIG. 8 is a configuration view illustrating a high-speed decoding reception unit shown in FIG. 6.

Referring to FIG. 8, the high-speed decoding reception unit 320 includes an inverting unit 321, a bit determining unit 322, and a decoding unit 323. The inverting unit 321 inverts the digital Q signal DDQ that is differentiated by the differential block 220. The bit determining unit 322 determines a bit ‘1’ when the signal from the inverting unit 321 is larger than a reference value, and a bit ‘0’ when the signal from the inverting unit 321 is smaller than the reference value. The decoding unit 323 decodes a bit signal from the bit determining unit 322 to detect the bit data.

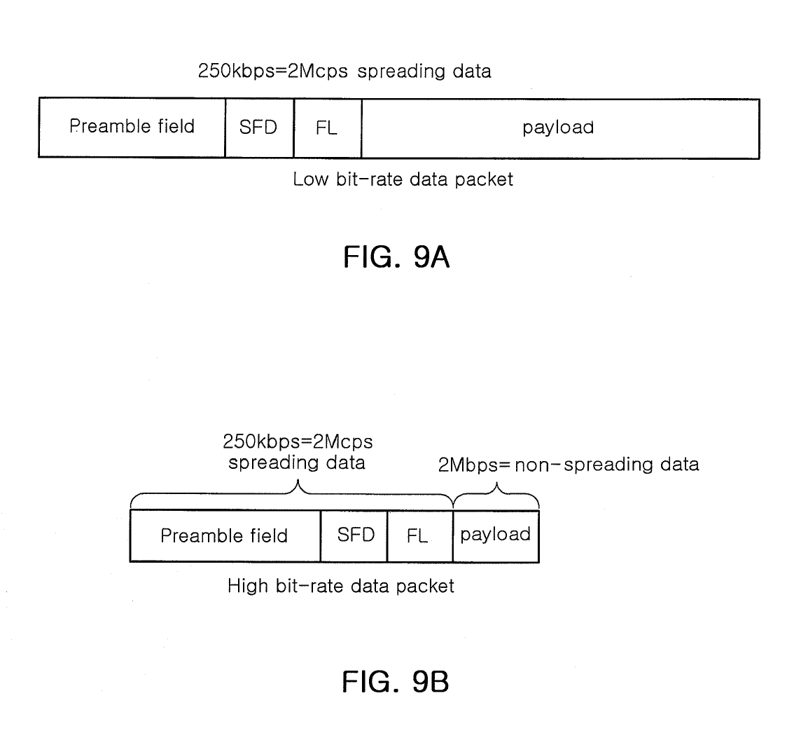

FIGS. 9A and 9B are structural views illustrating a low bit-rate data packet and a high bit-rate data packet.

FIG. 9A is a structural view illustrating a low bit-rate data packet. Referring to FIG. 9A, the low bit-rate data may have a data packet structure. The data packet structure includes a preamble field that contains preamble information for estimating timing synchronization, a start frame delimiter field that indicates a start frame, a frame length field that indicates a frame length, and a payload field that contains actual data.

At this time, the frame length field may contain low data rate mode information as data rate information DRI. Particularly, the low data rate mode information may be included in the most significant bit MSB of the frame length field.

Referring to FIG. 9B, the high bit-rate data may have a data packet structure. The data packet structure includes a preamble field that contains preamble information for estimating timing synchronization, a start frame delimiter field that indicates a start frame, a frame length field that indicates a frame length, and a payload field that contains actual data.

The frame length field may contain high data rate mode information as data rate information DRI. Particularly, the high data rate mode information may be included in the most significant bit MSB of the frame length field.

Referring to FIG. 6 and FIGS. 9A and 9B, the data rate determining block 400 can determine a data rate on the basis of the data rate information DRI that is included in the most significant bit MSB of the frame length field in the packet structure of the low bit-rate data from the low-speed despreading reception unit 310.

Hereinafter, the operation and effect of the present invention will be described in detail with the accompanying drawings.

The dual mode WPAN transceiver according to one exemplary embodiment of the present invention includes the dual mode WPAN transmitter according to another exemplary embodiment of the present invention and the dual mode WPAN receiver according to still another embodiment of the present invention.

Further, the dual mode WPAN transceiver according to the exemplary embodiment of the present invention can support both a low data rate of approximately 250 kbps and a high data rate of approximately 2 Mbps. In the dual mode WPAN transceiver that supports low and high data rates, a modem or a MAC checks a data rate to determine whether data will be transmitted at a rate of 250 kbps or at a rate of 2 Mbps. Further, the dual mode WPAN transceiver can control a data rate mode according to the determined data rate.

Hereinafter, the dual mode WPAN transmitter according to another exemplary embodiment of the present will be described with reference to FIGS. 2 to 5, and FIG. 9.

Referring to FIG. 2, when a mode selecting signal MS indicates a low data rate mode, the low-speed spreading transmission block 110 of the dual mode WPAN transmitter according to another exemplary embodiment of the present invention spreads the low bit-rate data LBD corresponding to the low data rate, divides the spread data into the digital I and Q signals DI and DQ, and outputs the digital signals DI and DQ to the analog waveform generating block 130.

when the mode selecting signal MS indicates a high data rate mode, the high-speed encoding transmission block 120 of the dual mode WPAN transmitter encodes the high bit-rate data HBD corresponding to the high data rate, divides the encoded high-bit rate data into the digital I and Q signals DI and DQ, and outputs the digital I and Q signals DI and DQ to the waveform generating block 130.

At this time, the analog waveform generating block 130 converts the digital I and Q signals DI and DQ from the low-speed spreading transmission block 110 or the high-speed encoding transmission block 120 into the analog I and Q signals AI and AQ, and output the analog I and Q signals AI and AQ.

Referring to FIG. 3, the bit/symbol converting unit 111 of the low-speed spreading transmission block 110 divides the low bit-rate data LBD corresponding to the low data rate of approximately 250 kbps (bit per second) into groups of bits, each having a predetermined number of bits. That is, the bit/symbol converting unit 111 divides the low bit-rate data LBD into groups of four bits, converts the data having four bits into symbols that are previously mapped, and outputs the symbols to the symbol/chip converting unit 112. That is, according to the IEEE 802.15.4 standard, 4-bit data matches one symbol. Bit data of approximately 250 kbps can be converted into symbols of approximately 62.5 ksps (symbol per second) (250/4=62.5).

Then, the symbol/chip converting unit 112 converts each of the symbols from the bit/symbol converting unit 111 into a chip signal that is previously mapped and includes a plurality of chips, and outputs the chip signal to the serial/parallel converting unit 113. That is, according to the IEEE 802.15.4 standard, one symbol is converted into a chip signal that has thirty two chips. Therefore, symbols of approximately 62.5 kbps are converted into chip signals of approximately 2 Mcpc (chip per second) (62.5×32=2000).

The serial/parallel converting unit 113 divides a serial chip signal from the symbol/chip converting unit 112 into odd-numbered chips and even-numbered chips to thereby generate the digital I and Q signals, respectively.

According to the above-described signal processing of the low-speed spreading transmission block 110, the low bit-rate data having four bits is converted into the chip signal having thirty two chips. As a result, the bit data is spread.

Referring to FIG. 4, the serial/parallel converting unit 121 of the high-speed encoding transmission block 120 divides the high bit-rate data HBD corresponding to the high data rate of approximately 2 Mbps into the odd-numbered bit sequence D1 and the even-numbered bit sequence D2, and outputs the odd-numbered bit sequence D1 and the even-numbered bit sequence D2 to the first encoding unit 122 and the second encoding unit 123, respectively.

The first encoding unit 122 encodes the odd-numbered bit sequence D1 from the serial/parallel converting unit 121 to generate the digital I signal DI. The second encoding unit 123 encodes the even-numbered bit sequence D2 from the serial/parallel converting unit 121 to generate the digital Q signal DQ.

As described above, when the bit data is encoded (pre-coded) and then transmitted, the final signal has FSK characteristics. In this way, the WPAN receiver can demodulate the signal by using FSK (frequency-shifting keying) that is a simpler scheme than PSK (phase-shift keying).

Referring to FIG. 5, the first pulse shaping unit 131 of the analog waveform generating block 130 converts the digital I signal DI from the low-speed spreading transmission block 110 or the high-speed encoding transmission block 120 into an analog pulse signal, and outputs the analog pulse signal to the first D/A unit 133.

Further, the second pulse shaping unit 132 of the analog waveform generating block 130 converts the digital Q signal DQ from the low-speed spreading transmission block 110 or the high-speed encoding transmission block 120 into an analog pulse signal, and outputs the analog pulse signal to the delay unit (TC) 134.

The first D/A unit 133 converts the analog pulse signal from the first pulse shaping unit 131 into the analog I signal AI.

The delay unit (TC) 134 delays the analog pulse signal from the second pulse shaping unit 132 by a predetermined period of time, and outputs the delayed signal to the second D/A unit 136. Here, according to the IEEE 802.15.4 standard, the delay time (TC) is approximately one chip period.

The second D/A unit 136 converts the analog pulse signal from the delay unit 134 into the analog Q signal AQ.

FIG. 9A is a structural view illustrating a low bit-rate data packet. Referring to FIG. 9A, the low bit-rate data may have a data packet structure. The data packet structure includes a preamble field that contains preamble information for estimating timing synchronization, a start frame delimiter field SFD that indicates a start frame, a frame length field FL that indicates a frame length, and a payload field that contains actual data.

Here, the frame length field FL may contain low data rate mode information as data rate information DRI. Particularly, the low data rate mode information may be included in the most significant bit MSB of the frame length field.

That is, the most significant bit MSB that is not currently used in the frame length field FL is used as a bit for storing the data rate information.

Hereinafter, the dual mode WPAN receiver according to still another exemplary embodiment of the present invention will be described with reference to FIGS. 6 to 8 and FIGS. 9A and 9B.

First, referring to FIG. 6, the A/D block 210 of the dual mode WPAN receiver according to still another exemplary embodiment of the present invention converts the analog I and Q signals AI and AQ into the digital I and Q signals DI and DQ, and outputs the digital I and Q signals DI and DQ to the differential block 220.

The differential block 220 obtains a phase difference between the digital I and Q signals DI and DQ from the A/D block 210 and complex signals adjacent thereto to offset phase errors of the digital I and Q signals DI and DQ, and outputs the differentiated digital I and Q signals DDI and DDQ to the timing estimation block 230, the data rate determining block 400, and a low-speed and high-speed reception block 300.

Here, the complex signals are generated by delaying the digital I and Q signals DI and DQ from the A/D block 210 by the predetermined period of time and conjugating the delayed signals.

The timing estimation block 230 estimates a timing synchronization point on the basis of preamble information of the digital I and Q signals DDI and DDQ that are differentiated by the differential block 220, and outputs a timing synchronization point signal to the low-speed and high-speed reception block 300.

The data rate determining block 400 determines whether it is a low data rate mode or a high data rate mode on the basis of the data rate information DRI that is included in the low bit-rate data from the low-speed despreading reception unit 310, and informs the low-speed and high-speed reception block 300 of the determined data rate mode.

Referring to FIGS. 9A and 9B, each of the data packet structure according to the low data rate of 250 kbps and the data packet structure according to the high data rate of 2 Mbps has the preamble field, the start frame delimiter field SFD, and the frame length fields FL that use the low data rate of 250 kbps. Therefore, synchronization is acquired by using the same timing estimator.

Then, the start frame delimiter field SFD is checked, and the frame length field FL is detected. According to the data rate information DRI stored in the most significant bit MSB of the frame length field FL, the low-speed and high-speed reception block 300 detects symbols at a high data rate of 2 Mbps or at a low data rate of 250 kbps.

The low-speed and high-speed reception block 300 includes the low-speed despreading reception unit 310 and the high-speed decoding reception unit 320. The low-speed despreading reception unit 310 despreads the digital I and Q signals DDI and DDQ, which are differentiated by the differential block 220, according to the timing synchronization point, which is estimated by the timing estimation block 230, so as to detect the low bit-rate data LBD. Further, the low-speed despreading reception unit 310 continues to perform the above-described operation when the data rate determining block 400 determines a low data rate mode, and stops the operation when the data rate determining block 400 determines a high data rate mode.

When the data rate determining block 400 determines the high data rate mode, the high-speed decoding reception unit 320 decodes (de-precodes) the digital I and Q signals DDI and DDQ that are differentiated by the differential block 220 according to the timing synchronization point that is estimated by the timing estimation block 230 so as to detect the high bit-rate data HBD.

Referring to FIG. 7, the correlation unit 311 of the low-speed despreading reception unit 310 correlates the digital I and Q signals DDI and DDQ, which are differentiated by the differential block 220, to the plurality of reference PN codes that are set beforehand. Further, the correlation unit 311 outputs a plurality of correlation values according to each of the signals to the maximum value detecting unit 312.

The maximum value detecting unit 312 detects the maximum correlation value from the plurality of correlation values from the correlation unit 311, and outputs the maximum correlation value to the symbol detecting unit 313.

The symbol detecting unit 313 detects a symbol that is previously mapped to the maximum correlation value that is detected by the maximum value detecting unit 312, and outputs the detected symbol to the symbol/bit converting unit 314.

The symbol/bit converting unit 314 converts the symbol detected by the symbol detecting unit 313 into bit data that is previously mapped to the symbol.

According to the above-described signal processing of the low-speed despreading reception unit 310, a chip signal having thirty two chips is converted into data having four bits. As a result, the received signals are despread.

Referring to FIG. 8, the inverting unit 321 of the high-speed decoding reception unit 320 inverts the digital Q signal DDQ that is differentiated by the differential block 220, and outputs the inverted digital Q signal DDQ to the bit determining unit 322.

The bit determining unit 322 determines a bit ‘1’ when the signal from the inverting unit 321 is larger than a reference value, and a bit ‘0’ when the signal from the inverting unit 321 is smaller than the reference value, and outputs a bit signal to the decoding unit 323.

The decoding unit 323 decodes the bit signal from the bit determining unit 322 so as to detect the bit data.

Referring to FIG. 9B, the high bit-rate data may have a data packet structure. The data packet structure includes the preamble field that contains preamble information for estimating timing synchronization, a start frame delimiter field that indicates a start frame, a frame length field that indicates a frame length, and a payload field that contains actual data.

The frame length field may contain high data rate mode information as data rate information (DRI). Particularly, the high data rate mode information may be included in the most significant bit MSB of the frame length field.

The data rate determining block 400 can determine a data rate on the basis of the data rate information DRI that is included in the most significant bit MSB in the frame length field of the packet structure of the low bit-rate data from the low-speed despreading reception unit 310.

Referring to FIGS. 9A and 9B, when the packet structure for the low bit-rate data shown in FIG. 9A is compared with the packet structure for the high bit-rate data shown in FIG. 9B, the low bit-rate data shown in FIG. 9A includes low speed data (250 kbps) from the preamble field to the payload field, while the high bit-rate data shown in FIG. 9B includes low speed data (250 kbps) in the preamble field, the start frame delimiter field SFD, and the frame length field FL, and high speed data (2 Mbps) in the payload field.

That is, in the WPAN receiver, the timing estimation block (or synchronization acquiring unit) can be shared between the low data rate mode and the high data rate mode, which prevents an increase in hardware. Further, in order that data rate information is carried on packet data, and a rate at which data is received can be determined on the basis of the data that is detected by the WPAN receiver, low-speed (250 kbps) spreading data is used in the preamble field, the start frame delimiter field SFD, and the frame length field FL, and high-speed (2 Mbps) non-spreading data is used in the payload field.

As described above, according to the exemplary embodiments of the present invention, the transceiver capable of supporting the high data rate of 2 Mbps as well as the low data rate of 250 kbps that is defined in the IEEE 802.15.4 standard is proposed.

As set forth above, according to the exemplary embodiments of the invention, the dual mode WPAN transceiver is configured to prevent a significant increase in system size and support both a low data rate of 250 kbps and a high data rate of 2 Mbps. Therefore, a data rate can be appropriately determined according to channel environment to thereby improve the system's adaptability.

That is, the dual mode WPAN transceiver that can support data rates of 250 kbps and 2 Mbps according to the exemplary embodiments of the present invention have the following advantages.

According to the related art, a data rate of 250 kbps can only be supported. However, the dual mode WPAN transceiver according to the exemplary embodiment of the present invention can automatically select a data rate between 250 kbps or 2 Mbps according to channel environment, such that various types of schemes, such as a standard data rate scheme, a scheme of using both a standard data rate and a high data rate, and a high data rate scheme, can be used for the required applications.

Further, the dual mode WPAN transceiver according to the exemplary embodiments of the present invention is not configured by simply adding a system of 2 Mbps to a system of 250 kbps according to the related art. Rather, the dual mode WPAN transceiver uses the existing system resources as much as possible, which causes a small increase of 10% or less in gate size.

While the present invention has been shown and described in connection with the exemplary embodiments, it will be apparent to those skilled in the art that modifications and variations can be made without departing from the spirit and scope of the invention as defined by the appended claims.

What is claimed is:

1. A dual mode WPAN transmitter comprising:
a low-speed spreading transmission block spreading low bit-rate data corresponding to a low data rate and dividing the low bit-rate data into digital I and Q signals in low data rate mode;
a high-speed encoding transmission block encoding high bit-rate data corresponding to a high data rate and dividing the high bit-rate data into digital I and Q signals in high data rate mode; and
an analog waveform generating block converting the digital I and Q signals from the low-speed spreading transmission block or the high-speed encoding transmission block into analog I and Q signals.

2. The dual mode WPAN transmitter of claim 1, wherein the low-speed spreading transmission block comprises:
a bit/symbol converting unit dividing the low bit-rate data corresponding to the low data rate into groups of bits, each group having a predetermined number of bits, and converting the data divided into groups of bits into symbols previously mapped;
a symbol/chip converting unit converting each of the symbols from the bit/symbol converting unit into a chip signal having a plurality of chips and previously mapped; and
a serial/parallel converting unit dividing a serial chip signal from the symbol/chip converting unit into odd-numbered chips and even-numbered chips to generate digital I and Q signals.

3. The dual mode WPAN transmitter of claim 1, wherein the low bit-rate data has a data packet structure including a preamble field containing preamble information for estimating timing synchronization, a start frame delimiter field indicating a start frame, a frame length field indicating a frame length, and a payload field containing actual data, and includes low data rate mode information as data rate information in the frame length field.

4. The dual mode WPAN transmitter of claim 3, wherein the low data rate mode information is included in the most significant bit of the frame length field.

5. The dual mode WPAN transmitter of claim 1, wherein the low data rate is approximately 250 kbps.

6. The dual mode WPAN transmitter of claim 1, wherein the high-speed encoding transmission block comprises:
a serial/parallel converting unit dividing the high bit-rate data corresponding to the high data rate into an odd-numbered bit sequence and an even-numbered bit sequence;
a first encoding unit encoding the odd-numbered bit sequence from the serial/parallel converting unit to generate the digital I signal; and
a second encoding unit encoding the even-numbered bit sequence from the serial/parallel converting unit to generate the digital Q signal.

7. The dual mode WPAN transmitter of claim 3, wherein the high bit-rate data has a data packet structure including a preamble field containing preamble information for estimating timing synchronization, a start frame delimiter field indicating a start frame, a frame length field indicating a frame length, and a payload field containing actual data, and includes high data rate mode information as data rate information in the frame length field.

8. The dual mode WPAN transmitter of claim 7, wherein the high data rate mode information is included in the most significant bit of the frame length field.

9. The dual mode WPAN transmitter of claim 1, wherein the high data rate is approximately 2 Mbps.

10. The dual mode WPAN transmitter of claim 1, wherein the analog waveform generating block comprises:
a first pulse shaping unit converting the digital I signal from the low-speed spreading transmission block or the high-speed encoding transmission block into an analog pulse signal;
a second pulse shaping unit converting the digital Q signal from the low-speed spreading transmission block or the high-speed encoding transmission block into an analog pulse signal;
a first D/A unit converting the analog pulse signal from the first pulse shaping unit into an analog I signal;
a delay unit delaying the analog pulse signal from the second pulse shaping unit by a predetermined period of time; and
a second D/A unit converting the analog pulse signal from the delay unit into an analog Q signal.

11. A dual mode WPAN receiver comprising:
an A/D block converting analog I and Q signals into digital I and Q signals;
a differential block obtaining a phase difference between the digital I and Q signals from the A/D block and complex signals adjacent thereto to offset phase errors of the digital I and Q signals;
a timing estimation block estimating a timing synchronization point on the basis of preamble information of the digital I and Q signals differentiated by the differential block;
a low-speed despreading reception unit despreading the digital I and Q signals differentiated by the differential block according to the timing synchronization point estimated by the timing estimation block to detect low bit-rate data, and stopping the operation in high data rate mode;
a data rate determining block determining whether it is a low data rate mode or a high data rate mode on the basis of data rate information included in the low bit-rate data from the low-speed despreading reception unit; and
a high-speed decoding reception unit decoding the digital I and Q signals differentiated by the differential block according to the timing synchronization point estimated by the timing estimation block to detect high bit-rate data.

12. The dual mode WPAN receiver of claim 11, wherein the data rate information is included in the most significant bit of a frame length field in a packet structure of the digital I and Q signals differentiated by the differential block.

13. The dual mode WPAN receiver of claim 11, wherein the low-speed despreading reception unit comprises:
a correlation unit correlating the digital I and Q signals differentiated by the differential block to a plurality of reference PN codes set beforehand;
a maximum value detecting unit detecting a maximum correlation unit among a plurality of correlation values from the correlation unit;
a symbol detecting unit detecting a symbol previously mapped to the maximum correlation value detected by the maximum value detecting unit; and
a symbol/bit converting unit converting the symbol detected by the symbol detecting unit into bit data previously mapped to the symbol.

14. The dual mode WPAN receiver of claim 11, wherein the high-speed decoding reception unit comprises:
an inverting unit inverting the digital Q signal differentiated by the differential block;
a bit determining unit determining a bit ‘1’ when the signal from the inverting unit is larger than a reference value and a bit ‘0’ when the signal from the inverter is smaller than the reference value; and
a decoding unit decoding a bit signal from the bit determining unit to detect bit data.

15. A dual mode WPAN transceiver comprising:
a WPAN transmitter including a low-speed spreading transmission block spreading low bit-rate data corresponding to a low data rate and dividing the low bit-rate data into digital I and Q signals in low data rate mode;
a high-speed encoding transmission block encoding high bit-rate data corresponding to a high data rate and dividing the high bit-rate data into digital I and Q signals in high data rate mode; and
an analog waveform generating block converting the digital I and Q signals from the low-speed spreading transmission block or the high-speed encoding transmission block into analog I and Q signals, and
a WPAN receiver including an A/D block converting analog I and Q signals into digital I and Q signals;
a differential block obtaining a phase difference between the digital I and Q signals from the A/D block and complex signals adjacent thereto to offset phase errors of the digital I and Q signals;
a timing estimation block estimating a timing synchronization point on the basis of preamble information of the digital I and Q signals differentiated by the differential block;
a low-speed despreading reception unit despreading the digital I and Q signals differentiated by the differential block according to the timing synchronization point estimated by the timing estimation block to detect low bit-rate data, and stopping the operation in high data rate mode;
a data rate determining block determining whether it is a low data rate mode or a high data rate mode on the basis of data rate information included in the low bit-rate data from the low-speed despreading reception unit; and
a high-speed decoding reception unit decoding the digital I and Q signals differentiated by the differential block according to the timing synchronization point estimated by the timing estimation block to detect high bit-rate data.

16. The dual mode WPAN transceiver of claim 15, wherein the low-speed spreading transmission block comprises:
a bit/symbol converting unit dividing the low bit-rate data corresponding to the low data rate into groups of bits, each group having a predetermined number of bits, and converting the data divided into groups of bits into symbols previously mapped;
a symbol/chip converting unit converting each of the symbols from the bit/symbol converting unit into a chip signal having a plurality of chips and previously mapped; and
a serial/parallel converting unit dividing a serial chip signal from the symbol/chip converting unit into odd-numbered chips and even-numbered chips to generate digital I and Q signals.

17. The dual mode WPAN transceiver of claim 15, wherein the low bit-rate data has a data packet structure including a preamble field containing preamble information for estimating timing synchronization, a start frame delimiter field indicating a start frame, a frame length field indicating a frame length, and a payload field containing actual data, and includes low data rate mode information as data rate information in the frame length field.

18. The dual mode WPAN transceiver of claim 17, wherein the low data rate mode information is included in the most significant bit of the frame length field.

19. The dual mode WPAN transceiver of claim 15, wherein the low data rate is approximately 250 kbps.

20. The dual mode WPAN transceiver of claim 15, wherein the high-speed encoding transmission block comprises:
a serial/parallel converting unit dividing the high bit-rate data corresponding to the high data rate into an odd-numbered bit sequence and an even-numbered bit sequence;
a first encoding unit encoding the odd-numbered bit sequence from the serial/parallel converting unit to generate the digital I signal; and
a second encoding unit encoding the even-numbered bit sequence from the serial/parallel converting unit to generate the digital Q signal.

21. The dual mode WPAN transceiver of claim 15, wherein the high bit-rate data has a data packet structure including a preamble field containing preamble information for estimating timing synchronization, a start frame delimiter field indicating a start frame, a frame length field indicating a frame length, and a payload field containing actual data, and includes low data rate mode information as data rate information in the frame length field.

22. The dual mode WPAN transceiver of claim 21, wherein the low data rate mode information is included in the most significant bit of the frame length field.

23. The dual mode WPAN transceiver of claim 15, wherein the high data rate is approximately 2 Mbps.

24. The dual mode WPAN transceiver of claim 15, wherein the analog waveform generating block comprises:
a first pulse shaping unit converting the digital I signal from the low-speed spreading transmission block or the high-speed encoding transmission block into an analog pulse signal;
a second pulse shaping unit converting the digital Q signal from the low-speed spreading transmission block or the high-speed encoding transmission block into an analog pulse signal;
a first D/A unit converting the analog pulse signal from the first pulse shaping unit into an analog I signal;
a delay unit delaying the analog pulse signal from the second pulse shaping unit by a predetermined period of time; and
a second D/A unit converting the analog pulse signal from the delay unit into an analog Q signal.

25. The dual mode WPAN receiver of claim 15, wherein the data rate information is included in the most significant bit of a frame length field in a packet structure of the digital I and Q signals differentiated by the differential block.

26. The dual mode WPAN receiver of claim 15, wherein the low-speed despreading reception unit comprises:
a correlation unit correlating the digital I and Q signals differentiated by the differential block to a plurality of reference PN codes set beforehand;
a maximum value detecting unit detecting a maximum correlation unit among a plurality of correlation values from the correlation unit;
a symbol detecting unit detecting a symbol previously mapped to the maximum correlation value detected by the maximum value detecting unit; and
a symbol/bit converting unit converting the symbol detected by the symbol detecting unit into bit data previously mapped to the symbol.

27. The dual mode WPAN transceiver of claim 15, wherein the high-speed decoding reception unit comprises:
an inverting unit inverting the digital Q signal differentiated by the differential block;
a bit determining unit determining a bit ‘1’ when the signal from the inverting unit is larger than a reference value and a bit ‘0’ when the signal from the inverter is smaller than the reference value; and
a decoding unit decoding a bit signal from the bit determining unit to detect bit data.
